(19) United States
(12) Patent Application Publication
(10) Pub. No.: US 2026/0072874 A1
(43) Pub. Date: Mar. 12, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: YOHEI OKATANI, Kanagawa (JP)

(21) Appl. No.: 19/312,532

(22) Filed: Aug. 28, 2025

(30) Foreign Application Priority Data
Sep. 10, 2024 (JP) 2024-156553

(51) Int. Cl. G06F 16/16; H04N 1/32

(52) U.S. Cl. CPC G06F 16/164; G06F 16/168; H04N 1/32128

(57) ABSTRACT

An image processing apparatus displays a type of a document, which is represented by image data and identified by analysis processing on the image data and a file name of a file including the image data, which is generated based on a rule set in association with the corresponding type on a single screen and allows for accepting of correction of the type and the file name.

### BACKGROUND

### Field of the Technology

The present disclosure relates to a technique of filing a scanned image.

### Description of the Related Art

In a case of filing a scanned image obtained by scanning and the like of a document such as an order form, a character string extracted from the corresponding scanned image by character recognition processing (OCR processing) is confirmed and corrected by a user visually and manually and is utilized as a file name and the like. As a technique of assisting the operations performed visually and manually by the user, Japanese Patent Laid-Open No. 2023-35548 discloses a technique of displaying a screen that prompts the user to perform the confirmation and the correction.

### SUMMARY

An image processing apparatus according to an aspect of the present disclosure displays a type of a document, which is represented by image data and identified by analysis processing on the image data and a file name of a file including the image data, which is generated based on a rule set in association with the corresponding type on a single screen and allows for accepting of correction of the type and the file name.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration example of an image processing system.

FIG. 2 is a diagram illustrating a hardware configuration example of an MFP.

FIG. 3 is a diagram illustrating a hardware configuration example of an external storage.

FIG. 4 is a diagram illustrating a software configuration example of the MFP.

FIG. 5 is a flowchart illustrating a flow of processing executed by the MFP.

FIG. 6 is a diagram illustrating a document example.

FIG. 7 is a flowchart illustrating a detailed flow of accepting processing of confirmation and correction by a user.

FIGS. 8A to 8D are diagrams illustrating a UI screen example.

FIGS. 9A and 9B are diagrams illustrating a UI screen example.

FIG. 10 is a flowchart illustrating a detailed flow of the accepting processing of the confirmation and the correction by the user.

FIG. 11 is a flowchart illustrating a detailed flow of the accepting processing of the confirmation and the correction by the user.

FIG. 12 is a flowchart illustrating a detailed flow of the accepting processing of the confirmation and the correction by the user.

FIGS. 13A to 13C are diagrams illustrating a UI screen example.

### DESCRIPTION OF THE EMBODIMENTS

Embodiments of a technique of the present disclosure are described below in detail with reference to the drawings. Note that the following embodiments are not intended to limit the technique of the present disclosure according to the scope of claims. Not all the combinations of characteristics described in the embodiments are necessarily required for the means for solving the problems of the technique of the present disclosure, and the multiple characteristics may be combined arbitrarily. Note that the same configurations are described by providing the same reference numerals. Additionally, each step in a flowchart is described by prepending “S.”

### First Embodiment

### Overall Configuration

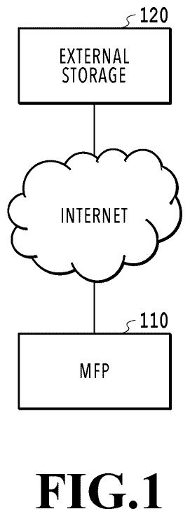

FIG. 1 is a diagram illustrating a schematic configuration example of an image processing system according to the present embodiment. The image processing system of the present embodiment includes a multifunction peripheral (MFP) 110 and an external storage 120. The MFP 110 is communicably connected to a server that provides various services on the Internet by way of a local area network (LAN).

The MFP 110 is a multifunction peripheral having multiple functions of a scanner, a printer, and the like and is an example of an information processing apparatus. The MFP 110 also has a function of transferring a file of a scanned image obtained by scanning a document to an external storage and the like that into which the file can be saved. Note that the information processing apparatus of the present embodiment is not limited to the multifunction peripheral including the scanner and the printer and may be a personal computer (PC) or the like.

The external storage 120 executes a service that allows for saving of various data such as the file of the scanned image received via the Internet and obtainment of the file from an external apparatus via a web browser. The external storage 120 is a cloud service, for example. The number of the external storage 120 is not limited to one and there may be multiple external storages 120.

The image processing system of the present embodiment is a configuration including the MFP 110 and the external storage 120; note that it is not limited thereto. For example, a part of the function and the processing of the MFP 110 may be executed by another server arranged on the Internet and the LAN. Additionally, the external storage 120 may be arranged on the LAN instead of the Internet. Moreover, the external storage 120 may be replaced with an e-mail server or the like and may attach the file of the scanned image obtained by scanning the document to an e-mail and transmit the e-mail. The MFP 110 may also have the saving function of the external storage 120.

### Hardware Configuration of MFP

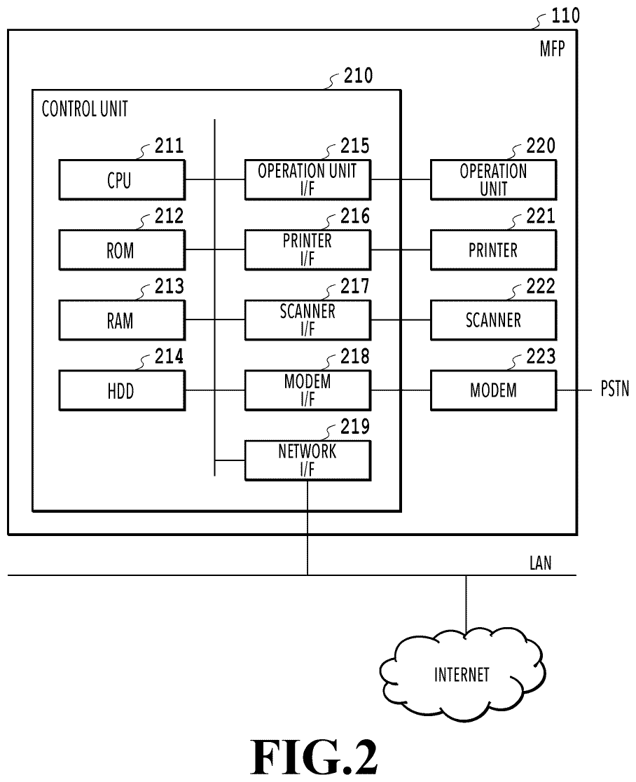

FIG. 2 is a diagram illustrating a hardware configuration example of the MFP 110. The MFP 110 includes a control unit 210, an operation unit 220, a printer 221, a scanner 222, and a modem 223. The control unit 210 includes a CPU 211, a ROM 212, a RAM 213, an HDD 214, an operation unit I/F 215, a printer I/F 216, a scanner I/F 217, a modem I/F 218, and a network I/F 219.

The CPU 211 controls an operation of overall the MFP 110 by reading out a control program stored in the ROM 212 and the HDD 214 to the RAM 213 to execute, and various functions of the MFP 110 such as reading/printing/communication are executed. The ROM 212 stores a program such as an OS executed by the CPU 211 to control the operation of the MFP 110, a parameter required to execute the program, and the like. The RAM 213 is used as a temporal storage region such as a main memory and a working area of the CPU 211. Note that, although the single CPU 211 executes each processing illustrated in a flowchart described later by using a single storage unit (the RAM 213 or the HDD 214) in the present embodiment, it is not limited thereto. For example, multiple CPUs and multiple RAMs or HDDs may cooperate to execute each processing. The HDD 214 is a mass-storage unit that stores the image data and various programs.

The operation unit I/F 215 is an interface connecting the operation unit 220 and the control unit 210. The operation unit 220 includes a displaying device such as a liquid crystal monitor including a touch panel, a keyboard, and the like to accept an operation by the user and notify the CPU 211 of an instruction according to an input by the user operation.

The printer I/F 216 is an interface connecting the printer 221 and the control unit 210. The image data for printing is transferred to the printer 221 from the control unit 210 via the printer I/F 216 and printed on a printing medium such as a sheet in a predetermined size by the printer 221. The scanner I/F 217 is an interface connecting the scanner 222 and the control unit 210. The scanner 222 generates scanned image data by scanning the document set on a not-illustrated platen glass or automatic original document reading apparatus (auto document feeder: ADF) and inputs the scanned image data to the control unit 210 via the scanner I/F 217. The MFP 110 can perform copying to output the scanned image data generated by the scanner 222 from the printer 221 as a print product, and additionally it is possible to perform file transmission and e-mail transmission to the outside. The modem I/F 218 is an interface connecting the modem 223 and the control unit 210. The modem 223 transmits and receives the image data by facsimile communication with a not-illustrated facsimile apparatus on a public switched telephone network (PSTN). The network I/F 219 is an interface connecting the control unit 210 (the MFP 110) to the LAN. The MFP 110 can transmit the image data and the information to each service on the Internet by using the network I/F 219 and can also receive various pieces of information.

### Hardware Configuration of External Storage

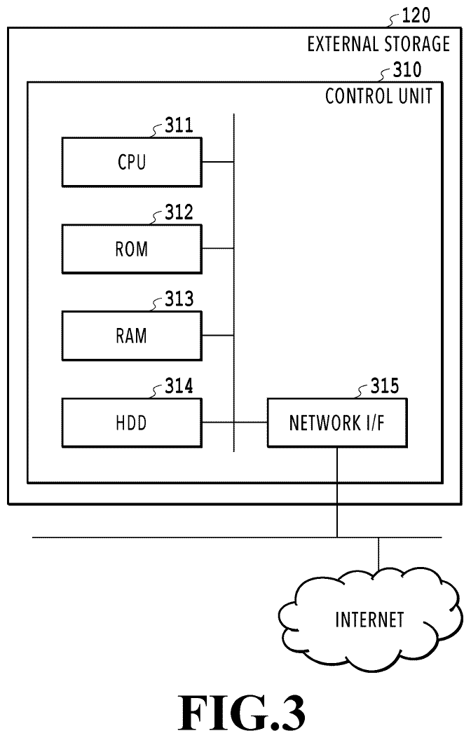

FIG. 3 is a diagram illustrating a hardware configuration example of the external storage 120. The external storage 120 includes a control unit 310. The control unit 310 includes a CPU 311, a ROM 312, a RAM 313, an HDD 314, and a network I/F 315. The CPU 311 controls an operation of overall the external storage 120 by reading out a control program stored in the ROM 312 to the RAM 313 to execute. The ROM 312 stores a program that can be executed by the CPU 311, a parameter required to execute the program, and the like. The RAM 313 is used as a temporal storage region such as a main memory and a working area of the CPU 311. The HDD 314 is a mass-storage unit that stores the image data and various programs. The network I/F 315 is an interface connecting the external storage 120 to the Internet. The external storage 120 performs processing such as transmission and reception and saving of various types of information according to a request notified by an external apparatus such as the MFP 110 via the network I/F 315.

### Software Configuration of MFP

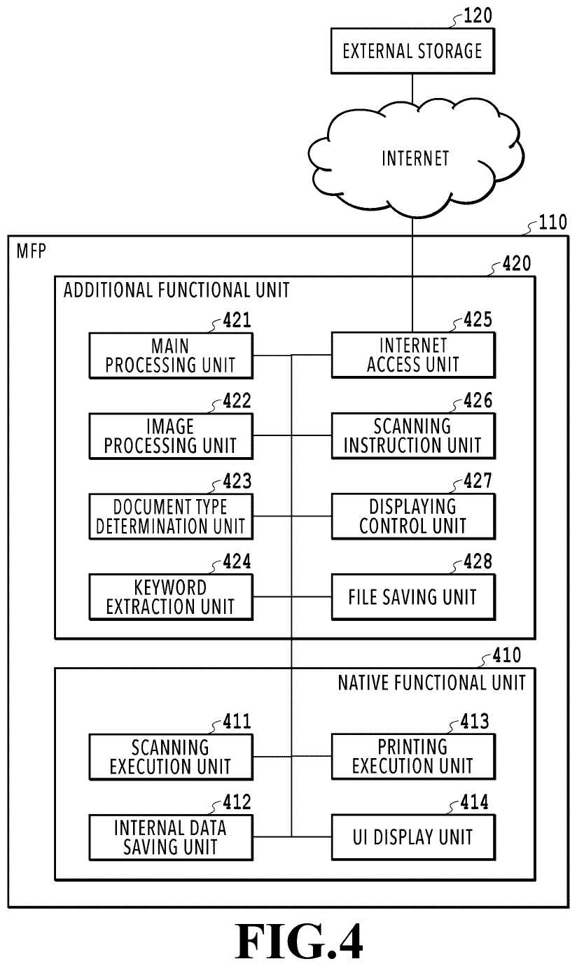

FIG. 4 is a diagram illustrating a software configuration example of the MFP. A functional block of the MFP 110 is roughly classified into two units, which are a native functional unit 410 and an additional functional unit 420. Each functional unit of the MFP 110 is implemented with the CPU 211 reading out the program stored in the ROM 212 and the HDD 214 to the RAM 213 to execute.

A scanning execution unit 411, an internal data saving unit 412, a printing execution unit 413, and a user interface (UI) display unit 414 included in the native functional unit 410 are generally included in the MFP 110. The additional functional unit 420 is an application additionally installed in the MFP 110. The additional functional unit 420 is an application based on Java (registered trademark) and can easily implement adding of a function to the MFP 110. Note that, another not-illustrated application may be additionally installed in the MFP 110.

As described above, the native functional unit 410 includes the scanning execution unit 411, the internal data saving unit 412, the printing execution unit 413, and the UI display unit 414. The additional functional unit 420 includes a main processing unit 421, an image processing unit 422, a document type determination unit 423, a keyword extraction unit 424, an Internet access unit 425, a scanning instruction unit 426, a displaying control unit 427, and a file saving unit 428.

According to a scanning request, the scanning execution unit 411 generates the scanned image data by scanning the document set on the platen glass by the scanner 222 via the scanner I/F 217. The internal data saving unit 412 saves the data to the HDD 214 and obtains the data from the HDD 214.

According to the generated image data for printing, the printing execution unit 413 executes processing of printing an image on the printing medium by the printer 221 via the printer I/F 216. The UI display unit 414 displays a UI screen on the touch panel of the operation unit 220 via the operation unit I/F 215.

The main processing unit 421 has a function of general processing of the additional functional unit 420. Specifically, the main processing unit 421 controls the overall processing of the additional functional unit 420 and requests each unit included in the additional functional unit 420 to perform processing.

The image processing unit 422 performs analysis processing on the image data. The image processing unit 422 performs processing for the image such as block selection (BS), character recognition (OCR), and rotation and inclination correction of the image on the image data. BS is an abbreviation for Block Selection, which is processing of extracting a rectangular region indicating a place of a character string from the image. OCR is an abbreviation for optical character recognition, which is processing of extracting the character string from the image.

The document type determination unit 423 determines a document type of the image data. The document type indicates a type of the document, which is an invoice, a receipt, a statement of delivery, a contract, and so on, for example. Any other types may be included. For example, a type of a document file such as a PDF file, a Word file, an Excel file, and a text file may be called the document type. In addition, a file name rule may be set for each type of the document file as described above.

Additionally, the document type may be determined by generating a learned model that has learned a term that is likely to appear for each document type as a pattern and using the generated learned model. Moreover, a determination unit that has learned a layout that is likely to appear for each document type as the pattern may be used. Furthermore, the above-described units may be used in combination. Any other means may be used. Additionally, a certainty may be calculated for the determined document type. The certainty is a degree indicating how much the recognized result is certain. For example, the certainty may be expressed in percentage like 99% or may be expressed by a level like high, medium, and low. Any other expression may be applied. For example, in a case where the determination unit that determines the document type probabilistically is used, a probability value used for the determination may be calculated as the certainty, or a degree of coincidence between results determined by different multiple determination units may be calculated as the certainty. The certainty may be calculated by any other means. The certainty and the calculation method of the certainty are similar concept and calculation method also in operations other than the document type determination.

The keyword extraction unit 424 extracts a keyword from the character string. The keyword indicates a word having a particular concept that frequently appears in the document, which is the character string indicating a concept such as a company name, a document number, a person name, a phone number, an address, an amount, and a date, for example. Any other words may be included. Additionally, a word meaning a type of the keyword such as the company name, the document number, the person name, the phone number, the address, the amount, and the date is called a keyword label. The extraction may be performed by an extractor that has learned a position in a context in which the keyword appears as the pattern. Additionally, the extraction may be performed by an extractor that has learned a position in the layout in which the keyword appears as the pattern. Moreover, the extraction may be performed by the above-described extractors in combination. The extractors may be used separately for each document type, or the same extractors may be used for a part of or all the document types. The extraction may be performed by any other means. The keyword that can be extracted may be different for each document type. Additionally, the certainty may be calculated for the extracted keyword.

The Internet access unit 425 transmits a processing request to a cloud service and the like that provide a storage function (a storage service). In general, the cloud service releases various interfaces that use a protocol such as REST and SOAP to save the file to the cloud storage and obtain the saved file from an external apparatus. The Internet access unit 425 operates the cloud service by using the released interface of the cloud service. The Internet access unit 425 transmits the image data to the external storage 120 via the network I/F 219.

The scanning instruction unit 426 requests the scanning execution unit 411 to perform scanning processing according to scanning setting inputted via the UI screen.

The displaying control unit 427 displays the UI screen to accept the operation by the user on the displaying device such as the liquid crystal monitor having the touch panel function of the operation unit 220 of the MFP 110. For example, an operation screen that accepts an operation to perform scanning setting and start scanning, confirmation of a preview of the scanned image obtained by scanning the document and a file name described later, and an operation to perform output setting and start outputting is displayed.

The file saving unit 428 saves the image as the file by using file saving information. The file saving information is information required to save the file and includes a folder path, the file name, and the like, for example. Any other information may be included. The file saving unit 428 may save the file to the HDD 214 via the internal data saving unit 412 or may save the file to the external storage 120 via the Internet access unit 425. The file may be saved by any other means.

### Flow of Overall Processing

Processing described hereinafter is implemented with the CPU 211 of the MFP 110 reading out the control program stored in the ROM 212 and the HDD 214 to the RAM 213 and controlling overall the operations of the units of the MFP 110.

In the present embodiment, saving destination information and the file name rule corresponding to each document type are set in advance by operations of a manager and the user and saved to either the HDD 214 or the external storage 120. The saving destination information is information indicating a place to save the file and may include the folder name, the folder path, and a URL of the external storage. Any other information may be included.

The file name rule is a rule for setting the file name using the keyword. For example, the file name rule is a rule for setting the file name formed of “{company name}-{document number}-Yamada” and the like. {Company name} and {document number} are placeholders that are replaced with the keyword extracted by extraction processing of the keyword described later. For example, in a case where the keyword extracted as the keyword label “company name” is “C company limited,” and the keyword extracted as the keyword label “document number” is “001,” the file name is “C company limited-001-Yamada.” Only the keyword label that can be extracted for the corresponding document type can be designated to the placeholder, and any character may be set to the file name other than the placeholder.

The main processing unit 421 may obtain and hold the saving destination information and the file name rule via the internal data saving unit 412 and may obtain and hold the saving destination information and the file name rule via the Internet access unit 425. The saving destination information and the file name rule may be obtained and held by any other means.

### Processing Executed by MFP

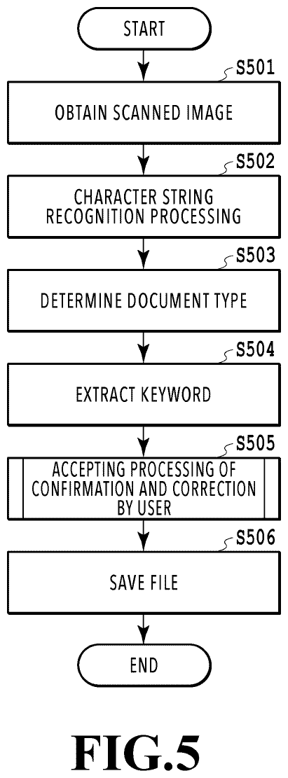

FIG. 5 is a flowchart illustrating a flow of the processing executed by the MFP 110. In FIG. 5, the file name is automatically generated from the scanned image obtained by scanning the document by the MFP 110, and the scanned image is saved with the generated file name. Note that, although an example in which the displaying control unit 427 displays the UI screen on the touch panel of the operation unit 220 is described in the present embodiment, it is not limited thereto. The displaying control unit 427 may provide each UI screen of the present embodiment to another apparatus, and an operation unit of the other apparatus may display each UI screen.

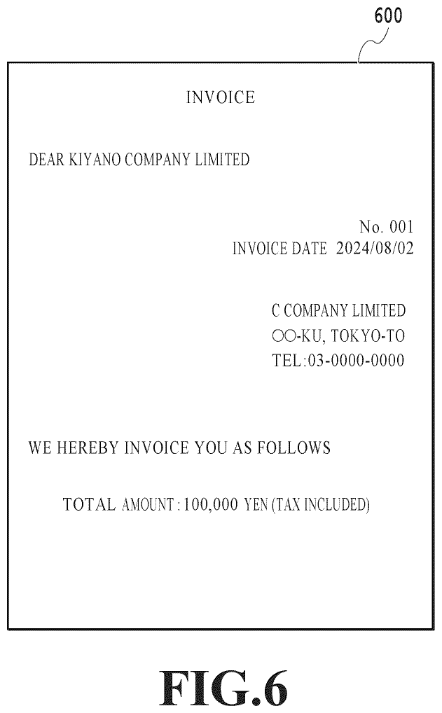

In S501, the main processing unit 421 requests the scanning instruction unit 426 to perform scanning and allows the scanning execution unit 411 to execute the scanning processing on the document set on the automatic original document reading apparatus. Then, the main processing unit 421 obtains the image data (the scanned image data) that is a scanning processing result by the scanning execution unit 411. The scanned image obtained in this process is an image of a page unit. The main processing unit 421 obtains the scanned image data obtained by scanning a document 600 illustrated in FIG. 6, for example.

In S502, the main processing unit 421 requests the image processing unit 422 to perform character string recognition processing. The image processing unit 422 generates corrected image data by correcting incline and rotation of the image data obtained in S501. Subsequently, the image processing unit 422 executes the block selection (BS) processing on the corrected image data to detect a character string region (a character string block) corresponding to the character string and executes the character recognition (OCR) processing on the character string region. The generated corrected image data, the character string region as a BS processing result, and the character string as an OCR processing result are saved to the RAM 213.

In S503, the main processing unit 421 requests the document type determination unit 423 to determine the document type. The document type determination unit 423 determines the document type by using the corrected image data, the character string region, and the character string obtained in S502.

In S504, the main processing unit 421 requests the keyword extraction unit 424 to extract the keyword. The keyword extraction unit 424 extracts the keyword by using the character string region and the character string obtained by the detection and the like in S502 and the document type determined in S503. Note that the keyword extraction unit 424 may extract the keyword that can be extracted from all the document types. In a case where only the keyword that can be extracted from the document type determined in S503 is extracted, and the document type is corrected on a correction screen described later, the keyword that can be extracted from the corrected document type may be extracted again. The keyword may be extracted in any other order.

In S505, the main processing unit 421 requests the displaying control unit 427 to display the UI screen to accept confirmation and correction by the user. The displaying control unit 427 generates the UI screen by using the document type determined in S503 and the keyword extracted in S504 and displays the UI screen on the touch panel of the operation unit 220. Additionally, once the user operation on a save button described later is accepted on the UI screen, the displaying control unit 427 determines property information shown on the UI screen. The property information includes the saving destination information indicating a saving destination of the scanned image, the file name of the scanned image, and the document type; however, for example, the property information may at least include the saving destination information and the file name of the scanned image. Alternatively, the property information may at least include the file name of the scanned image and the document type. Alternatively, the property information may at least include the saving destination information and the file name of the scanned image.

### Accepting Processing of Confirmation and Correction by User

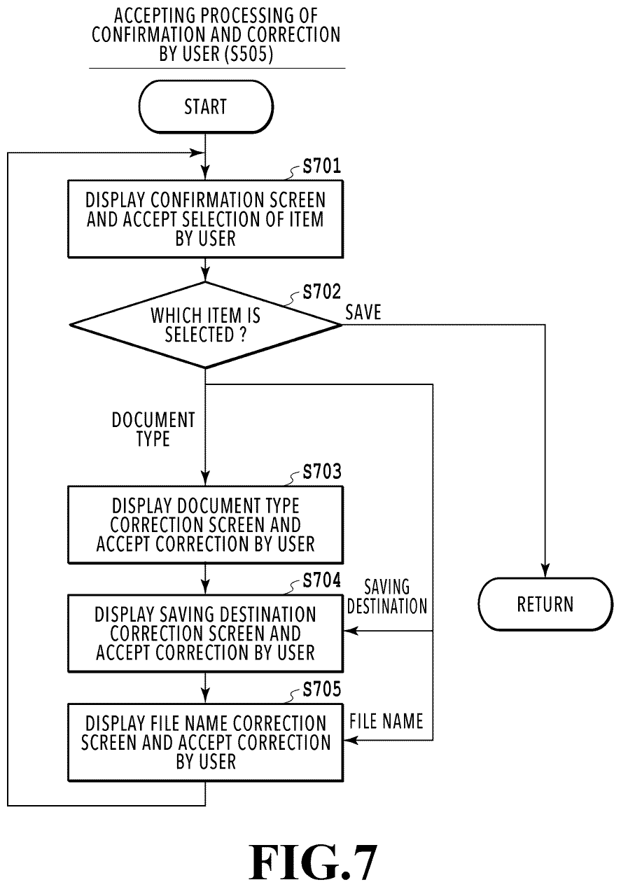

FIG. 7 is a flowchart illustrating a detailed flow of accepting processing of the confirmation and the correction by the user (S505).

In S701, the displaying control unit 427 generates and displays a confirmation screen (a summary screen) showing information related to the document type and information related to the saving destination and the file name included in the file saving information. Additionally, the displaying control unit 427 accepts the user operation to select a specific item out of multiple items shown on the confirmation screen such as the document type, the saving destination, and the file name. Alternatively, the user operation to press the save button shown on the confirmation screen is accepted.

### Confirmation Screen

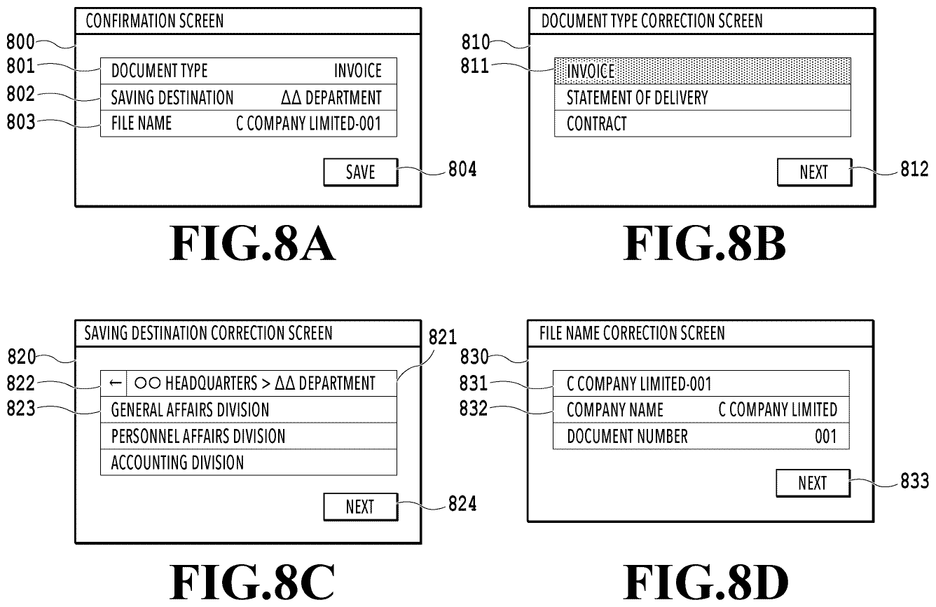

FIG. 8A is a diagram illustrating an example of the confirmation screen according to the present embodiment. A confirmation screen (a summary screen) 800 displays a document type item 801, a saving destination item 802, a file name item 803, and a save button 804 to be able to accept the selection and the pressing by the user operation. However, the confirmation screen 800 is configured so as not to allow the user to correct the character string used in each of the document type item 801, the saving destination item 802, and the file name item 803. Note that, the confirmation screen 800 may display the property information that is used in a case of filing the scanned image, which is information that needs to be confirmed by the user. The confirmation screen 800 may display any other configuration.

The document type item 801 is an item to display the information related to the document type designated by the user operation. By default, the displaying control unit 427 displays the information related to the document type determined in S503. In a case where the correction by the user is accepted on a document type correction screen described later, the correction is reflected, and the display of the document type item 801 is updated. Note that, in a case where the document type item 801 is designated by the user, the screen transitions to the document type correction screen that allows the user to correct the document type.

The saving destination item 802 is an item to display the saving destination information designated by the user operation. By default, the displaying control unit 427 refers to the saving destination information held by the main processing unit 421 and displays the saving destination information corresponding to the document type designated in the document type item 801. In a case where the correction by the user is accepted on a saving destination correction screen described later, the correction is reflected, and the display of the saving destination item 802 is updated. Note that, in a case where the saving destination item 802 is designated by the user, the screen transitions to the saving destination correction screen that allows the user to correct the character string used in the saving destination information.

The file name item 803 is an item to display the file name designated by the user operation. By default, the displaying control unit 427 refers to the file name rule held by the main processing unit 421 and generates and displays the file name based on the file name rule corresponding to the document type designated in the document type item 801. Specifically, the displaying control unit 427 generates and displays the file name by replacing the placeholder of the file name rule with a corresponding keyword from the keywords extracted in S504. In a case where the correction by the user is accepted on a file name correction screen described later, the correction is reflected, and the display of the file name item 803 is updated. Note that, in a case where the file name item 803 is designated by the user, the screen transitions to the file name correction screen that allows the user to correct the character string used in the file name of the scanned image.

The save button 804 is a button to execute saving with the file saving information being displayed. In a case where the user presses the save button 804, the displaying control unit 427 determines the property information with the contents displayed on the confirmation screen 800.

Referring back to the description of FIG. 7. In S702, the displaying control unit 427 determines which item is selected by the user on the confirmation screen 800. If it is determined that the document type item 801 is selected (document type in S702), the processing proceeds to S703. If it is determined that the saving destination item 802 is selected (saving destination in S702), the processing proceeds to S704. If it is determined that the file name item 803 is selected (file name in S702), the processing proceeds to S705. If it is determined that the save button 804 is selected (save in S702), the flow illustrated in FIG. 7 ends.

In S703, the displaying control unit 427 generates and displays the document type correction screen on which the document type can be designated.

### Document Type Correction Screen

FIG. 8B is a diagram illustrating a document type correction screen example. A document type correction screen 810 is the UI screen after transition, which is obtained in a case where the document type is designated by the user on the UI screen before the transition and the state transitions to a state in which the user can correct the document type. The document type correction screen 810 displays a document type list 811 and a next (transition) button 812. Note that the document type correction screen 810 may have any other configuration.

The document type list 811 indicates a list of candidates of the document type that can be designated by the user. Note that, in FIG. 8B, any one of invoice, statement of delivery, and contract can be designated in the document type list 811. By default, “invoice” that is the document type displayed in the document type item 801 is designated. The displaying control unit 427 designates the document type that is pressed by the user in the list of the document types. The document type list 811 may display the document type by sorting in the descending order of the certainty.

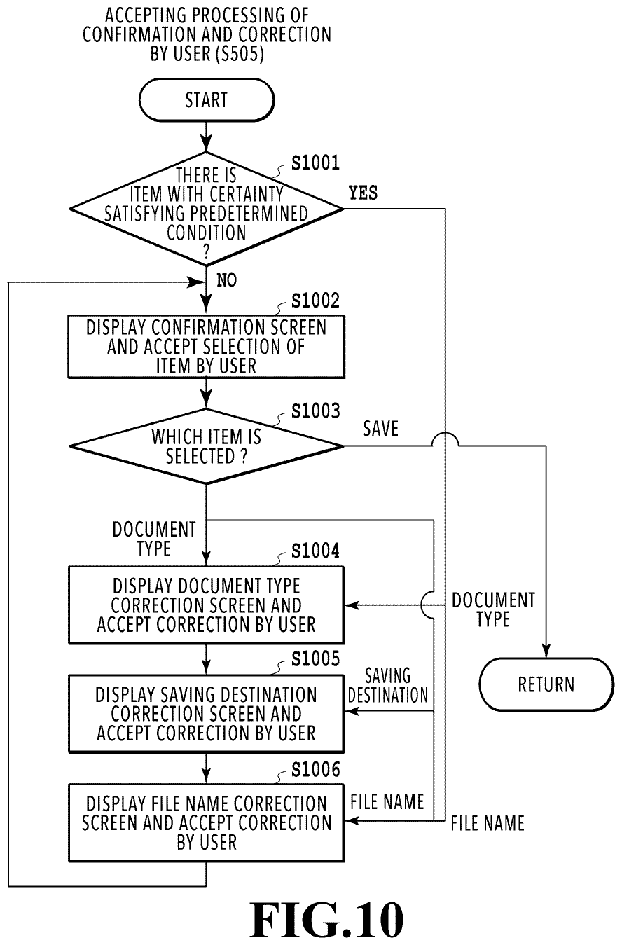

The next button 812 is a button to transition to the subsequent screen. In a case where the next button 812 is pressed by the user, the correction is reflected, and the displaying control unit 427 updates the saving destination information and the file name corresponding to the document type designated on the document type correction screen 810. Specifically, in a case where the document type is corrected on the document type correction screen 810, based on the designated document type after the correction, the saving destination information is identified and the file name is generated again by the same method as the method described in FIG. 8A. Then, in S704 described later, the saving destination correction screen in which the identified new saving destination information is inputted is displayed. Then, in S705 described later, the file name correction screen in which the generated new file name is inputted is displayed. That is, the new file name that is generated according to the file name rule associated with the document type after the correction, which is different from the file name rule associated with the document type before the correction, is displayed on the file name correction screen. Additionally, an alert message to confirm whether to update may be displayed before update, and update may be performed in a case of updating in response to the pressing by the user, and update may not be performed in a case of not updating. Once the user presses the next button 812, the processing proceeds to S704. Note that, the processing of generating and updating again the saving destination information and the file name according to the correction of the document type described herein may be similarly performed in flowcharts in FIGS. 10 to 12.

Referring back to the description of FIG. 7. In S704, the displaying control unit 427 generates and displays the saving destination correction screen on which the saving destination information can be designated.

### Saving Destination Correction Screen

FIG. 8C is a diagram illustrating a saving destination correction screen example. A saving destination correction screen 820 is the UI screen after transition, which is obtained in a case where the saving destination information is designated by the user on the UI screen before the transition and the state transitions to a state in which the user can correct the character string used in the saving destination information. The saving destination correction screen 820 displays a folder path item 821, a parent folder button 822, a folder list 823, and a next (transition) button 824. Note that the saving destination correction screen 820 may include information of another external storage, or any other configuration may be applied.

The folder path item 821 is an item to display the folder path of the saving destination information. By default, the saving destination information displayed in the saving destination item 802 is displayed.

The parent folder button 822 is a button to change the folder path to a folder layer immediately above. In a case where the pressing by the user is received, the displaying control unit 427 changes the folder path of the saving destination information to the layer immediately above. For example, in a case where the current folder path of the saving destination information is “/○○ headquarters/ΔΔ department”, the folder path is changed to “/○○ headquarters.”

The folder list 823 indicates a list of candidates of the folder in the folder path of the saving destination information that can be designated by the user. In a case where the pressing by the user is received, the displaying control unit 427 changes the folder path of the saving destination information to the designated folder. For example, in a case where the folder path of the saving destination information before the designation by the user is performed is “/○○ headquarters/ΔΔ department” and the user designates “general affairs division,” the folder path is changed to “/○○ headquarters/ΔΔ department/general affairs division.” Note that, the folder list 823 displays the folder corresponding to the folder path indicated in the folder path item 821. In a case where the parent folder button 822 is pressed by the user, the folder list 823 displays the folder corresponding to the layer immediately above.

The next button 824 is a button to transition to the subsequent screen. In a case where the next button 824 is pressed by the user, the correction is reflected, and the displaying control unit 427 updates the saving destination information to that designated on the saving destination correction screen 820. Once the user presses the next button 824, the processing proceeds to S705.

Referring back to the description of FIG. 7. In S705, the displaying control unit 427 generates and displays the file name correction screen on which the file name can be designated. Note that once the processing in S705 ends, the processing proceeds to S701.

### File Name Correction Screen

FIG. 8D is a diagram illustrating a file name correction screen example. A file name correction screen 830 is a UI screen after transition, which is obtained in a case where the file name of the scanned image is designated by the user on the UI screen before the transition and the state transitions to a state in which the user can correct the character string used in the file name of the scanned image. The file name correction screen 830 displays a file name item 831, a keyword list 832, and a next (transition) button 833. Note that, the file name correction screen 830 may display any other configuration.

The file name item 831 is an item to display the character string forming the file name. By default, “C company limited-001” that is the file name displayed in the file name item 803 is displayed. In a case where the pressing by the user is received, the displaying control unit 427 corrects the file name. For example, the displaying control unit 427 may correct the file name to a file name formed of a free word inputted by utilizing a software keyboard (not illustrated). In a case where the keyword is deleted during the correction of the file name, the corresponding keyword is deleted from a keyword list described later. Additionally, a new placeholder of the keyword may be added. In a case where the placeholder of the keyword is added during the correction of the file name, the keyword added to the corresponding placeholder is added to the keyword list described later. The file name item 831 may be corrected by any other means.

The keyword list 832 is a list indicating the list of the multiple keywords to form the file name. In response to reception of pressing of any of the keywords by the user, the displaying control unit 427 corrects the keyword. For example, keyword candidates may be displayed and then the keyword may be corrected to a keyword designated by the user among the displayed keyword candidates. Instead, the keyword may be corrected to a keyword formed of a free word inputted by the user. The keyword indicated in the keyword list 832 may be corrected by any other means. Once the keyword is corrected, the correction is reflected, and the displaying control unit 427 updates the corresponding keyword in the file name item 831.

The next button 833 is a button to transition to the subsequent screen. In a case where the next button 833 is pressed by the user, the correction is reflected, and the displaying control unit 427 updates the file name to that corrected on the file name correction screen 830. Once the user presses the next button 833, the processing proceeds to S701.

Referring back to the description of FIG. 5. In S506, the main processing unit 421 requests the file saving unit 428 to save the file. The file saving unit 428 saves the corrected image data generated in S502 with the designated file name in the folder path of the designated saving destination information by using the file saving information determined in S505 via the internal data saving unit 412. Additionally, in a case where the saving destination information indicates the external storage 120, the file saving unit 428 saves the corrected image data to the external storage via the Internet access unit 425.

As described above, according to the present embodiment, the confirmation screen is displayed before the correction screen is displayed, and thus it is possible to omit the operation to correct the character string in a case where the corresponding character string used for the property information used in a case of filing the scanned image has no error. On the other hand, in a case where the character string used for the property information used in a case of filing the scanned image has an error, it is possible to transition to the correction screen to correct the corresponding character string and to perform the operation to correct the corresponding character string. Thus, in a case where the correction is unnecessary, comparing with a case of sequentially displaying the UI screens to set and correct the document type, the saving destination, and the file name one by one, the operation is simplified to only the confirmation performed on the confirmation screen displaying all the document type, the saving destination, and the file name. Additionally, in a case where the correction is necessary, it is possible to perform the correction on the correction screen to correct the corresponding item. Therefore, it is possible to suppress work of the user operation in a case of automatically filing the scanned image.

Incidentally, in a case of filing the scanned image, it is necessary to set the saving destination of the file, the file name, and the like. In a method of sequentially displaying the UI screens to set and correct the information one by one, the user needs to perform many operations, and it takes more work.

According to the present embodiment, it is possible to suppress work of the user operation in a case of filing the scanned image.

### Second Embodiment

In the present embodiment, an aspect in which the confirmation screen (the summary screen) corresponding to multiple pages of the scanned image is displayed is described. In the present embodiment, the determination of the document type and the extraction of the keyword are performed for each page, and the determination result and the extraction result are displayed in association with the page number. Note that, in the present embodiment, a difference from the first embodiment is mainly described.

### Confirmation Screen

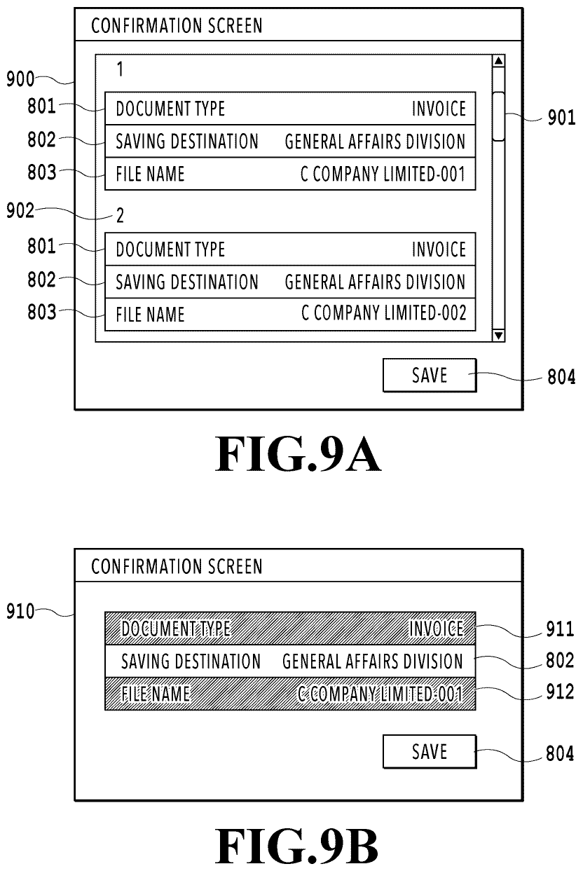

FIG. 9A is a diagram illustrating an example of the confirmation screen according to the present embodiment. A confirmation screen (a summary screen) 900 is a screen corresponding to the multiple pages of the scanned image as illustrated in FIG. 9A and displays the document type item 801, the saving destination item 802, and the file name item 803 of the confirmation screen 800 for the multiple pages. The confirmation screen 900 additionally displays a scroll bar 901 and a page number 902. Note that, although the confirmation screen 900 displays the above-described component, it is not limited thereto, and another component may be displayed.

The scroll bar 901 is a bar to accept an operation by the user to scroll the screen. In a case where the scroll bar 901 is slid by the operation by the user, the displaying control unit 427 displays the property information including the information related to each of the document type item 801, the saving destination item 802, and the file name item 803 in and after a third page that is out of a single screen and not being displayed.

The page number 902 is an item indicating the number of the page. The displaying control unit 427 displays the page number corresponding to the document type item 801, the saving destination item 802, and the file name item 803. In a case where each correction screen is displayed, the displaying control unit 427 corrects the document type, the saving destination information, and the file name belonging in the corresponding page number. Note that, in FIG. 9A, the document type item 801, the saving destination item 802, and the file name item 803 belonging in each of a first page and a second page are illustrated.

As described above, in the present embodiment, the property information of the multiple pages is displayed by scrolling the screen. Thus, even in a case where multiple pages of the documents are scanned, the user can confirm the property information on the multiple pages all at once on the single UI screen, and the convenience for the user is improved.

### Third Embodiment

In the present embodiment, an aspect in which the confirmation screen (the summary screen) on which an item with a low certainty is highlighted is displayed is described. Note that in the present embodiment, a difference from the first embodiment is mainly described.

### Confirmation Screen

FIG. 9B is a diagram illustrating an example of the confirmation screen according to the present embodiment. A confirmation screen (a summary screen) 910 is a screen on which the item with the low certainty is highlighted as illustrated in FIG. 9B and displays the document type item 801 and the file name item 803 on the confirmation screen 800 by changing into a document type item 911 and a file name item 912, respectively. Note that, although the confirmation screen 910 is formed of the above-described component, it is not limited thereto, and the confirmation screen 910 may be formed of another component.

The document type item 911 is an item to display the information related to the document type designated by the user operation. The displaying control unit 427 displays the document type item 911 in a highlighted manner in a case where the document type satisfies a predetermined condition. The predetermined condition is a condition for determining that it is necessary to prompt the user to perform confirmation. For example, it is a case where the certainty of the document type determined in S503 is lower than a predetermined threshold. Note that, the predetermined condition is not limited thereto, and any other condition may be applied. The displaying in a highlighted manner is a displaying method to prompt the user to perform the confirmation, which is color display, blinking display, and the like, for example. The displaying in a highlighted manner is not limited thereto, and any other displaying method may be applied.

The file name item 912 is an item to display the file name designated by the user operation. The displaying control unit 427 displays the file name item 912 in a highlighted manner in a case where the file name satisfies a predetermined condition. The predetermined condition is a condition for determining that it is necessary to prompt the user to perform the confirmation. For example, it is a case where the certainty of the keyword used in the file name is lower than a predetermined threshold. Note that, the predetermined condition is not limited thereto, and any other condition may be applied. The displaying in a highlighted manner is a displaying method to prompt the user to perform the confirmation, which is color display, blinking display, and the like, for example. The displaying in a highlighted manner is not limited thereto, and any other displaying method may be applied. The obtainment of the certainty may be done before executing the processing in S701 and, for example, may be executed before the processing in S505.

As described above, according to the present embodiment, the item with the low certainty is displayed in a highlighted manner on the confirmation screen, and thus the user can easily confirm the item that needs to be corrected, and the time required for the confirmation is shortened. Thus, it is possible to prompt the user to confirm the item that needs to be corrected and to improve the convenience.

### Fourth Embodiment

In the present embodiment, an aspect in which the UI screen is displayed according to the certainty is described. In the present embodiment, the displaying of the confirmation screen (the summary screen) is skipped in a case where the certainty is low in the document type determination or the keyword extraction, and the correction screen of the item determined to have the low certainty is displayed. Note that in the present embodiment, a difference from the first embodiment is mainly described. The obtainment of the certainty may be done before executing the processing in S1001 and, for example, may be executed before the processing in S505.

### Accepting Processing of Confirmation and Correction by User

FIG. 10 is a flowchart illustrating a detailed flow of the accepting processing of the confirmation and the correction by the user according to the present embodiment (S505). Note that, S1002 to S1006 is the same as S701 to S705, and detailed description thereof is omitted.

In S1001, the displaying control unit 427 determines whether the certainty of each of the document type determined in S503 and the keyword extracted in S504 satisfies a predetermined condition. The predetermined condition is a condition for determining that it is necessary to prompt the user to perform the correction. For example, it is a case where the certainty of the document type is lower than a predetermined threshold or a case where the certainty of the keyword is lower than a predetermined threshold. The predetermined condition is not limited thereto and may be any other condition. If it is determined that the certainty of the document type satisfies the predetermined condition (document type in S1001), the processing proceeds to S1004. If it is determined that the certainty of the keyword satisfies the predetermined condition (file name in S1001), the processing proceeds to S1006. If the certainty of the document type satisfies the predetermined condition and the certainty of the keyword satisfies the predetermined condition, a flow in a case where the certainty of the document type satisfies the predetermined condition is prioritized, and the processing proceeds to S1004. If it is determined that neither of the certainty of the document type and the certainty of the keyword satisfy the predetermined condition (NO in S1001), the processing proceeds to S1002.

As described above, in the present embodiment, displaying of the confirmation screen is skipped in a case where the certainty of at least one of the determination of the document type and the extraction of the keyword is lower than the predetermined threshold, and the correction screen of the item determined to have a lower certainty than the predetermined threshold is displayed. Thus, in a case where there is the item that needs to be corrected, displaying of the confirmation screen and displaying of the correction screen for the item that does not need to be corrected are omitted, and it is possible to suppress work of the user operation and to improve the convenience.

### Fifth Embodiment

In the present embodiment, an aspect in which the screen transitions to the confirmation screen (the summary screen) once the correction on each correction screen ends is described. Note that, in the present embodiment, a difference from the first embodiment is mainly described.

### Accepting Processing of Confirmation and Correction by User

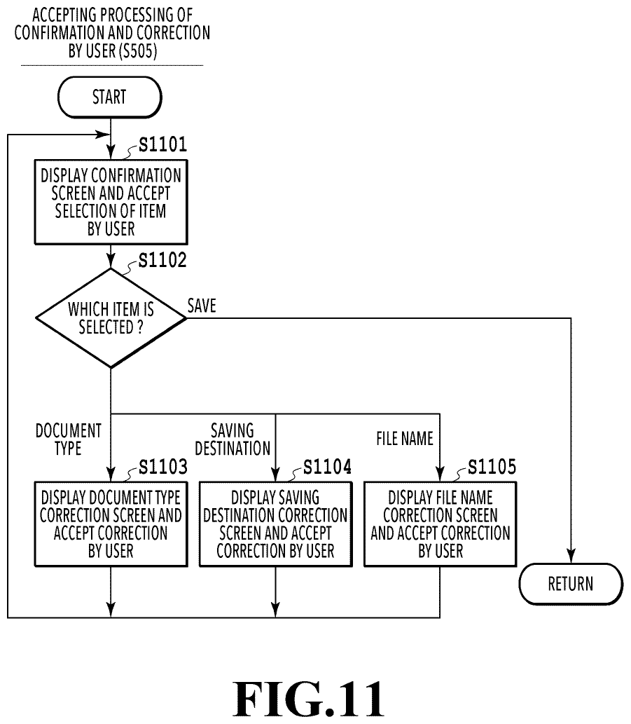

FIG. 11 is a flowchart illustrating a detailed flow of the accepting processing of the confirmation and the correction by the user according to the present embodiment (S505). Note that, S1101 and S1102 are the same as S701 and S702, and detailed description thereof is omitted.

In S1103, as with S703, the displaying control unit 427 generates and displays the document type correction screen on which the document type can be designated. Note that once the processing in S1103 ends, the processing proceeds to S1101.

In S1104, as with S704, the displaying control unit 427 generates and displays the saving destination correction screen on which the saving destination information can be designated. Note that, as with the case in S1103, once the processing in S1104 ends, the processing proceeds to S1101.

In S1105, as with S705, the displaying control unit 427 generates and displays the file name correction screen on which the file name can be designated. Note that, as with the case in S1103, once the processing in S1105 ends, the processing proceeds to S1101.

As described above, according to the present embodiment, once accepting of the correction by the user on each correction screen ends, the screen transitions to the confirmation screen, and thus it is possible to simplify the operation to only the user operation on the item that needs to be corrected. Thus, comparing with a case of sequentially displaying also the correction screen to correct the item that does not need to be corrected, it is possible to simplify the user operation and to improve the convenience. Additionally, since the user operation on the correction screen for the item that does not need to be corrected is reduced, it is possible to improve the convenience.

### Sixth Embodiment

In the present embodiment, an aspect in which the accepting processing of the confirmation and the correction by the user is executed also for the extracted keyword in addition to the document type, the saving destination, and the file name is described. Note that, in the present embodiment, a difference from the first embodiment is mainly described.

### Accepting Processing of Confirmation and Correction by User

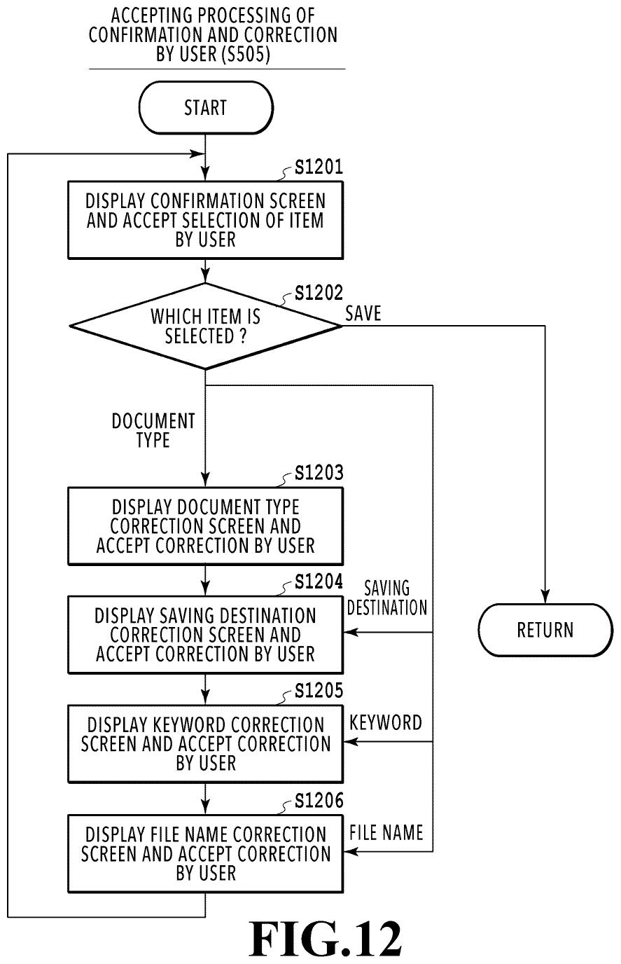

FIG. 12 is a flowchart illustrating a detailed flow of the accepting processing of the confirmation and the correction by the user according to the present embodiment (S505). Note that, S1203 and S1206 are the same as S703 and S705, and detailed description thereof is omitted.

In S1201, the displaying control unit 427 generates and displays the confirmation screen (the summary screen) showing the information related to the document type, the information related to the saving destination and the file name included in the file saving information, and the keyword. Additionally, the displaying control unit 427 accepts the user operation to select a specific item out of the multiple items such as the document type, the saving destination, the keyword, and the file name shown on the confirmation screen. Alternatively, the user operation to press the save button shown on the confirmation screen is accepted.

### Confirmation Screen

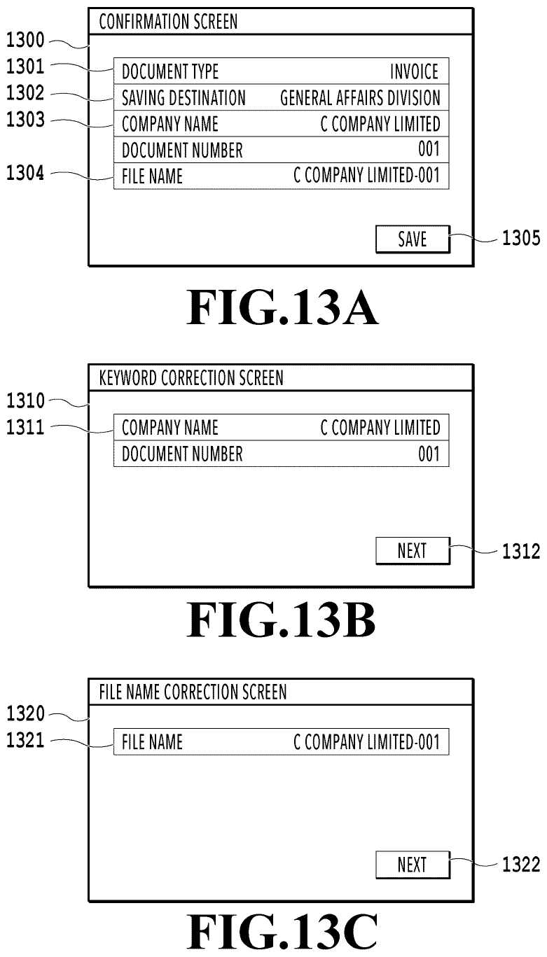

FIG. 13A is a diagram illustrating an example of the confirmation screen in the present embodiment. A confirmation screen (a summary screen) 1300 displays a document type item 1301, a saving destination item 1302, a keyword item 1303, a file name item 1304, and a save button 1305 so as to able to accept the selection and the pressing by the user operation. However, the confirmation screen 1300 is configured so as not to allow the user to correct the character string used in each of the document type item 1301, the saving destination item 1302, the keyword item 1303, and the file name item 1304. Note that, the confirmation screen 1300 may display the property information used in a case of filing the scanned image, which is information that needs to be confirmed by the user. Although the property information displayed on the confirmation screen 1300 includes the saving destination information indicating the saving destination of the scanned image, the file name of the scanned image, the document type, and the keyword; however, it is not limited thereto. The confirmation screen 1300 may display any other configuration. Note that, since the document type item 1301, the saving destination item 1302, the file name item 1304, and the save button 1305 have the same configuration as that of the document type item 801, the saving destination item 802, the file name item 803, and the save button 804, respectively, detailed description is omitted.

The keyword item 1303 is an item to display the keyword designated by the user. By default, the displaying control unit 427 displays the keyword used in the file name out of the keywords extracted in S504. In a case where the correction by the user is accepted on a keyword correction screen described later, the correction is reflected, and the display of the keyword item 1303 is updated. The number of the displayed keyword item 1303 may be the number of the keyword used in the file name. Note that, as for the keyword, a case where C company limited is extracted as the company name and 001 is extracted as the document number is illustrated in FIG. 13A. In a case where the keyword item 1303 is designated by the user, the screen transitions to the keyword correction screen that allows the user to correct the character string used as the keyword (a specific character string).

Referring back to the description of FIG. 12. In S1202, the displaying control unit 427 determines which item is selected by the user on the confirmation screen 1300. If it is determined that the document type item 1301 is selected (document type in S1202), the processing proceeds to S1203. If it is determined that the saving destination item 1302 is selected (saving destination in S1202), the processing proceeds to S1204. If it is determined that the keyword item 1303 is selected (keyword in S1202), the processing proceeds to S1205. If it is determined that the file name item 1304 is selected (file name in S1202), the processing proceeds to S1206. If it is determined that the save button 1305 is selected (save in S1202), the flow illustrated in FIG. 12 ends.

In S1204, as with S704, the displaying control unit 427 generates and displays the saving destination correction screen on which the saving destination information can be designated. Note that once the processing in S1204 ends, the processing proceeds to S1205.

In S1205, the displaying control unit 427 generates and displays the keyword correction screen on which the keyword can be designated. Note that once the processing in S1205 ends, the processing proceeds to S1206.

### Keyword Correction Screen

FIG. 13B is a diagram illustrating an example of the keyword correction screen according to the present embodiment. A keyword correction screen 1310 is a UI screen after transition in a case where the keyword (the specific character string) is designated by the user on the UI screen before the transition and the state transitions to a state in which the user can correct the keyword. The keyword correction screen 1310 displays a keyword list 1311 and a next (transition) button 1312. Note that the keyword correction screen 1310 is not limited to display the above configuration and may display any other configuration.

The keyword list 1311 is a list indicating a list of the keywords used in the file name. In a case where the pressing by the user is received, the displaying control unit 427 corrects the keyword. For example, the displaying control unit 427 may display keyword candidates and then correct to the keyword designated by the user among the displayed keyword candidates. Instead, the displaying control unit 427 may correct to the keyword formed of the free word inputted by utilizing the software keyboard (not illustrated). The keyword list 1311 may be corrected by any other means.

The next button 1312 is a button to transition to the subsequent screen. In a case where the next button 1312 is pressed by the user, the correction is reflected, and the displaying control unit 427 updates the file name to that using the keyword corrected on the keyword correction screen 1310. Additionally, an alert message to confirm whether to update may be displayed before update, and update may be performed in a case of updating in response to the pressing by the user, and update may not be performed in a case of not updating. Once the user presses the next button 1312, the processing proceeds to S1206.

Referring back to the description of FIG. 12. In S1206, as with S705, the displaying control unit 427 generates and displays the file name correction screen on which the file name can be designated. Note that, once the processing in S1206 ends, the processing proceeds to S1201.

### File Name Correction Screen

FIG. 13C is a diagram illustrating an example of the file name correction screen according to the present embodiment. A file name correction screen 1320 is a UI screen after transition in a case where the file name of the scanned image is designated by the user on the UI screen before the transition and the state transitions to a state in which the user can correct the character string used in the file name of the scanned image. The file name correction screen 1320 displays a file name item 1321 and a next (transition) button 1322. Note that the file name correction screen 1320 may display any other configuration. Note that since the next button 1322 has the same configuration as that of the next button 833 on the file name correction screen 830, description is omitted.

The file name item 1321 is an item to display the character string forming the file name. By default, “C company limited-001” that is the file name displayed in the file name item 1304 is displayed. In a case where the pressing by the user is received, the displaying control unit 427 corrects the file name. For example, the displaying control unit 427 may correct the file name to that formed of the free word inputted by utilizing the software keyboard (not illustrated). The file name item 1321 may be corrected by any other means.

As described above, according to the present embodiment, the correction screen on which only the extracted keyword can be corrected is displayed, and thus it is possible to separately perform the operations to correct the keyword and to correct the file name. Thus, the complication of the correction screen is reduced more than a case of using the correction screen formed to correct the keyword and the file name on the same screen. Additionally, it is possible to correct the desired keyword directly by the user and to improve the convenience.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to suppress work of a user operation in a case of filing a scanned image.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156553, filed Sep. 10, 2024, which is hereby incorporated by reference herein in its entirety.

What is claimed is:

1. An image processing apparatus comprising:
at least one memory that stores instructions; and
at least one processor that executes the instructions to:
display a type of a document, which is represented by image data and identified by analysis processing on the image data and a file name of a file including the image data, which is generated based on a rule set in association with the corresponding type on a single screen; and
allow for accepting of correction of the type and the file name.

2. The image processing apparatus according to claim 1, wherein
the single screen further displays a folder that is set in association with the type and into which the image data is saved, and
accepting of correction of a folder name of the folder is allowed.

3. The image processing apparatus according to claim 2, wherein
a user is not allowed to correct the type of the document, the folder name, and the file name on the single screen.

4. The image processing apparatus according to claim 1, wherein
the file name includes a character string extracted from the image data.

5. The image processing apparatus according to claim 2, wherein
in a case where one piece of information out of the type of the document, the folder name, and the file name is designated by a user, the single screen transitions to another screen that allows the user to correct the one piece of information designated by the user.

6. The image processing apparatus according to claim 5, wherein
in a case where the correction of the one piece of information ends, the other screen transitions to the single screen on which the correction of the one piece of information is reflected.

7. The image processing apparatus according to claim 5, wherein
in the displaying, a list of candidates of the folder name that can be designated by the user is displayed on the other screen after the transition in a case where the folder name is designated on the single screen.

8. The image processing apparatus according to claim 5, wherein
in the displaying, a character string used in the file name is displayed in a state that allows for the correction by the user on the other screen after the transition in a case where the file name is designated on the single screen.

9. The image processing apparatus according to claim 5, wherein
in the displaying, a list of candidates of the type of the document that can be designated by the user is displayed on the other screen after the transition in a case where the type of the document is designated on the single screen.

10. The image processing apparatus according to claim 5, wherein
in a case where the correction of the type of the document by the user ends on the other screen after the transition in a case where the type of the document is designated on the single screen, the single screen on which the correction of the type of the document is reflected is displayed, and
the folder name and the file name corrected based on the correction of the type of the document are displayed on the single screen on which the correction of the type of the document is reflected.

11. The image processing apparatus according to claim 2, wherein
information out of the type of the document, the folder name, and the file name that satisfies a predetermined condition is displayed in a highlighted manner on the single screen.

12. The image processing apparatus according to claim 2, wherein
in a case where there is information out of the type of the document, the folder name, and the file name that satisfies a predetermined condition, the single screen transitions to another screen that allows a user to correct the information satisfying the predetermined condition.

13. The image processing apparatus according to claim 2, wherein
in a case where there is information out of the type of the document, the folder name, and the file name that has a certainty lower than a predetermined threshold, the single screen transitions to another screen that allows a user to correct the information having the certainty lower than the predetermined threshold.

14. The image processing apparatus according to claim 2, wherein
in a case where there are a plurality of pages of the image data, the single screen displays the type of the document, the folder name, and the file name by a page unit.

15. An image processing method comprising:
displaying a type of a document, which is represented by image data and identified by analysis processing on the image data and a file name of a file including the image data, which is generated based on a rule set in association with the corresponding type on a single screen; and
allowing for accepting of correction of the type and the file name.

16. A non-transitory computer readable storage medium storing a program for causing a computer to perform an image processing method comprising:
displaying a type of a document, which is represented by image data and identified by analysis processing on the image data and a file name of a file including the image data, which is generated based on a rule set in association with the corresponding type on a single screen; and
allowing for accepting of correction of the type and the file name.
